(19) United States
(12) Patent Application Publication
(10) Pub. No.: US 2004/0122895 A1
(43) Pub. Date: Jun. 24, 2004

(54) Telecommunications service and method enabling users to physically meet

(75) Inventor: Christophe Gourraud, Montreal (CA)

Correspondence Address: SANDRA BEAUCHESNE, Ericsson Canada Inc., Patent Department (LMC/I/P), 8400 Decarie Blvd., Town Mount Royal, QC, H4P 2N2, CA

(73) Assignee: Telefonaktiebolaget L M Ericsson (publ)

(21) Appl. No.: 10/326,628

(22) Filed: Dec. 23, 2002

(51) Int. Cl. G06F 15/16; H04L 12/16; H04Q 11/00

(52) U.S. Cl. 709/204; 370/260

(57) ABSTRACT

The present invention provides a service node and method for enabling a face-to-face meeting between users of a face-to-face service of a telecommunications network wherein the face-to-face service has a plurality of users subscribed thereto. User profiles pertaining to pertaining to a plurality of registered users are marked and processed to identify at least two compatible user profiles. Therefore, the invention enables a physical face-to-face communication between at least two users having compatible user profiles. This is achieved by providing information found in the compatible user profiles to at least one of the at least two users having the compatible user profiles.

### BACKGROUND OF THE INVENTION

1. Field of the Invention

The present invention relates to providing a telecommunications service to users enabling them to physically meet each other.

2. Description of the Related Art

In the last decade, with the tremendous success of the Internet, a concept of virtual community has developed, which permits individuals to communicate with each other and share interests in a virtual world. However, the concept of virtual community does not answer the basic human need for real person-to-person contact.

Indeed, the virtual communities are built around exchanging information on a common interest such as, for example, games, sport, children or shopping. In most virtual communities, each member chooses a nickname that is used to communicate with other members. The nickname is usually a unique identifier of each member.

Virtual communities can be based on news groups where messages are posted and organised around threads of messages related to the same subject. A first member of the community posts a first message and other members are free to post their own messages related to the first message. The first message can be seen as a root of a tree of messages. In most news groups, the replies are organised around the first message or the root and each reply in the tree can have its own branch of replies. In some other news groups, only the root of the tree can receive replies. There usually exist at least one moderator per news group whose role is to control, if needed, the content of the posted messages. The mechanism behind news group can either be a Hypertext Transfer Protocol (HTTP) application or a Network News Transport Protocol (NNTP) server. The NNTP server behaviour is described in the Internet Engineering Task Force (IETF) Request for Comment (RFC) number 977 (RFC 977) and with extensions in RFC 2980. The HTTP application takes advantage of the HTTP specification (found in RFC 1945, RFC 2616 and RFC 2817), especially the POST and GET methods of the protocol.

Another type of virtual community is based on live discussion between available members in a virtual environment organized in multiple virtual chat rooms. This type of virtual community can either use an Internet Relay Chat (IRC) server or an HTTP application. IRC is specified by . . . The HTTP application, again, uses the HTTP specification to provide the virtual environment. In both cases, the member first logs into the virtual environment and chooses one chat room. Each chat room has its own identifier in the form of a subject or descriptive title. While the members are free to travel between chat rooms, the same members usually visit the same chat rooms. Some chats room may also be protected by a password known only to a limited group of members. Like for the news groups, there are moderators in the virtual environment and usually in each chat room to control, if needed, the discussed content.

Yet another type of virtual community is based on availability of members at any given moment. This type of community is sometime referred to as instant messaging community. Each member of such community usually registers their identity once with the main server and establishes a list of other members that should be tracked. The identity of each member is usually registered through a nickname chosen by each member. Depending on the virtual community, the nickname may or not be unique in the virtual community. If the nickname is not unique in the virtual community, a unique registration number is usually given to each member by the main server. Once connected to the Internet, each member can update their current status from a list ranging from available to unavailable (e.g. available, invisible, away, unavailable). At the same time, each member sees availability of each member from their list of other members. In this type of community, the main feature is to send personal messages to any member in the list of members. Each personal message is delivered when the corresponding member connects to the Internet. Obviously, personal messages are usually exchanged between available members. It is also possible for each member to open a chat room and to invite other members to join a live discussion. In some of those virtual communities, a list of interests can be linked to each member that wishes to find other members. This enables some virtual matches to be made by the main server. In such cases, a message is sent to both parties stating that the main server identified another member sharing a common set of interests. Each party can then choose to add the other party to their list of members. In this last type of virtual community, there is usually no moderator since each member has the capacity to block or ignore other members. Finally, it should be noted that this type of virtual community does not provide any mechanism to migrate from the virtual community to any kind of face-to-face meeting. An example of this type of virtual community is based on the ICQ software.

As it can be appreciated, no prior art solution provides any facilitating mechanism enabling people to meet each other. The present invention answers that need.

### SUMMARY OF THE INVENTION

The present invention is directed to a method for enabling a face-to-face meeting between users of a face-to-face service of a telecommunications network wherein the face-to-face service has a plurality of users subscribed thereto. The method comprise a step of registering a plurality of users of the face-to-face service wherein each of the plurality of users has an associated user profile. The method further includes steps of marking the associated user profiles pertaining to the plurality of registered users and processing the marked user profiles to identify at least two compatible user profiles. Therefore, the method enables a physical face-to-face communication between at least two users having compatible user profiles. This is achieved by providing information found in the compatible user profiles to at least one of the at least two users having the compatible user profiles.

The present invention is further directed to a service node for providing a face-to-face service in a telecommunications network. The service node comprises a profile repository capable of maintaining user profiles having information about users of the face-to-face service and marking a plurality of user profiles pertaining to registered users of the face-to-face service. The service node further comprises a processing module capable of processing the marked user profiles to identify at least two compatible user profiles. A communication module is further included in the service node, which capable of communicating with other nodes of the telecommunications network and communicating with the users of the face-to-face service by providing information found in compatible user profiles to at least one registered user of the face-to-face service so as to enable a physical face-to-face communication between compatible users.

### BRIEF DESCRIPTION OF THE DRAWINGS

A more complete understanding of the present invention may be had by reference to the following Detailed Description when taken in conjunction with the accompanying drawings wherein:

FIG. 1 is a nodal operation and signal flow diagram of an exemplary use of the face-to-face service implementation in a telecommunications network;

FIG. 2 is an exemplary schematic representation of a nodal architecture of the face-to-face service implementation in a telecommunications network; and

FIG. 3 is an exemplary schematic representation of a node architecture of the face-to-face service implementation in a telecommunications network in the context of a manhunt-type game.

### DETAILED DESCRIPTION OF THE PREFERRED EMBODIMENTS

The present invention intends to bring value back into the notion of face-to-face interactions between people. Among other aspects, the present invention is a location-based service using mobility in order to permit people sharing interests to meet each other. As such, it can be an interesting complement to the virtual communities described earlier. It can make use of HTTP, user geographical location, usage of electronic maps, multimedia sessions, chat, instant messaging, presence and conferencing. More particularly, the present invention can be used in an IP Multimedia network (IPMM), such as the one standardized by 3GPP and called IP Multimedia Subsystem Core Network (IMS). Session Initiation Protocol (SIP)-based messaging can be used to support the present invention, within the Internet or within the IPMM network of a telecommunications operator.

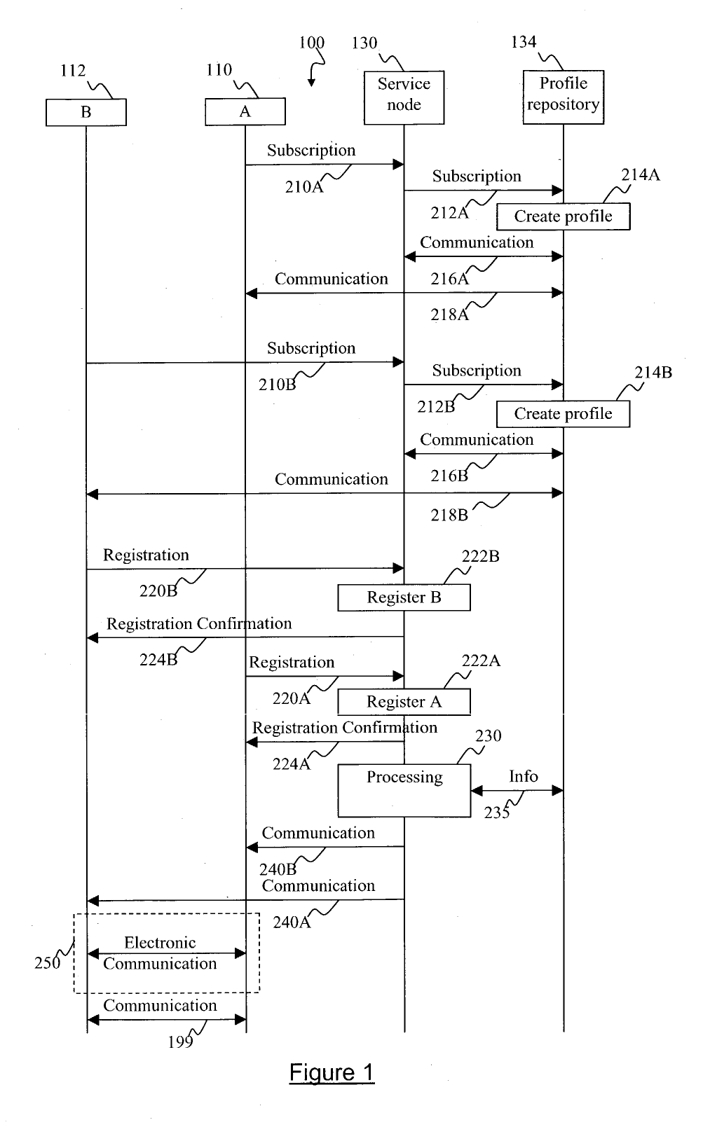

Reference is now made to FIG. 1, which shows a nodal operation and signal flow diagram of an exemplary use of the face-to-face service implementation in the telecommunications network 100. A first user A 110 and a second user B 112 are presented using the face-to-face service. For clarity purposes, only two users A 110 and B 112 are presented on FIG. 1, but the face-to-face service is built to handle a plurality of users simultaneously. FIG. 1 also shows a service node 130 and a profile repository 134 for providing the face-to-face service.

In order to use the face-to-face service, the user A 110 has to subscribe to the face-to-face service. For that purpose, a subscription message 210A is sent from the user A 110 to the service node 130. The subscription message 210A can be the result of an invitation to subscribe sent by the telecommunications network's 100 operator or from a direct action of the user A 110. The invitation form the operator can be, for example, a Short Message Service (SMS) message or Multimedia Message Service (MMS) message. Examples of direct actions include visiting a web site and sending the subscription message 210A by clicking on a hypertext link provided therein.

Following reception of the subscription message 210A, the service node 130 sends a subscription message 212A to the profile repository 134 to create a user profile (step 214A) associated to the user A 110. The step 214A may be performed by the profile repository 134 by creating the user profile associated to the user A 110 from a default profile containing some pre-filled information fields. The profile repository then communicates (216A and 218A) with the service node 130 or the user A 110 or both the service node 130 and the user A 110 to personalize the user profile associated with the user A 110. In cases where the profile repository 134 communicates 216A with the service node 130, the service node 130 may further communicate (not shown) with other nodes (not shown) of the telecommunications network 100 to gather information about the user A 110. For example, the service node 130 may communicate with a Home Location Register (HLR) or a Home Subscriber Service (HSS) associated to the user A 110 to get information about active services and send back the information to the profile repository 134. In cases where the profile repository 134 communicates 218A with the user A 110, the communication 218A usually takes the aspect of at least one interactive web page sent to the user A 110. The web page can be built using Hypertext Markup Language (HTML), eXtensible Markup Language (XML), any type of scripting language (e.g. JavaScript, VBScript). The communication 218A can also use any other proprietary interfacing between the profile repository 134 and the user A 110.

FIG. 1 also shows subscription of the user B 112 to the face-to-face service through steps 210B, 212B, 214B, 216B and 218B, which correspond to the steps 210A, 212A, 214A, 216A and 218A performed for subscription of the user A 110. The only difference between the two groups of steps is the adaptation of the content of the various messages to the user B 112.

Once subscribed, the users A 110 and B 112 can register to the face-to-face service to access its functionalities. Registration can occur following an explicit request from a subscribed user, following an invitation sent by the telecommunications network's 100 operator to a subscribed user or automatically following an event detected by the service node 130 or another node in the telecommunications network 100. Examples of the detected event can be detection that the subscribed user is entering a geographical zone (e.g. register in downtown Montreal), time of the day (e.g. register between 7 PM and 3 AM), etc. Both the explicit request and the invitation can be exchanged through the use of interactive web pages as described earlier. Proprietary interfaces can also be built for the same purposes. In all situations, the registration starts when a message is sent from the subscribed user to the service node 130.

FIG. 1 shows registration of the user B 112 with a registration message 220B from the user B 112 to the service node 130. If the user B 112 has more than one user profile associated therewith, the registration message 220B may further include information permitting the service node 130 to choose which user profile to register. For example, the information can be explicit naming of a user profile, it can be based on other information provided in the message such as UE information or based on location information deducted by the service node 130. Upon reception of the registration message 220B, the service node 130 marks the user B 112 as registered (step 222B). The step 222B can be performed in various ways. However, most implementations use a list of all registered users of the face-to-face service maintained in the service node 130 (inside or outside the profile repository 134 ). Another way of marking the registered users is to add a property to each user profile in order to maintain the registration status therein. Yet another way of marking the registered users is to copy user profiles of registered users in a different memory area of the profile repository 134 or of the service node 130 thus differentiating between registered and unregistered users. Following the step 222B, a registration confirmation message 224B may be sent to the user B 112 to confirm termination of the registration process. The registration confirmation message 224B may further include an interactive web page permitting the user B 112 to access an interactive web page built for the user B 112 or for all the registered users. The interactive web page could contain various links to enable user profile updates, deregistration, etc. FIG. 1 also shows registration of the user A 110 through steps 220A to 224A, which correspond, but for the user A 110, to the steps 220B to 224B already described. The two groups of steps differ from each other mostly because the content of the various messages is adapted to the user A 110. Another exemplary way to register the users A 110 and B 112 is via presence. The users A 110 and B 112 can modify their presence information and register to the face-to-face service thereby. In such a case, the service node 130 receives the registration message 220B or 220A in the form of a SIP NOTIFY message. The service node 130 may have to send a SIP SUBSCRIBE message to a presence server 142 in order to receive the SIP NOTIFY message. An added value of this exemplary approach is that the presence information may also include the current geographic location of the users A 110 and B 112.

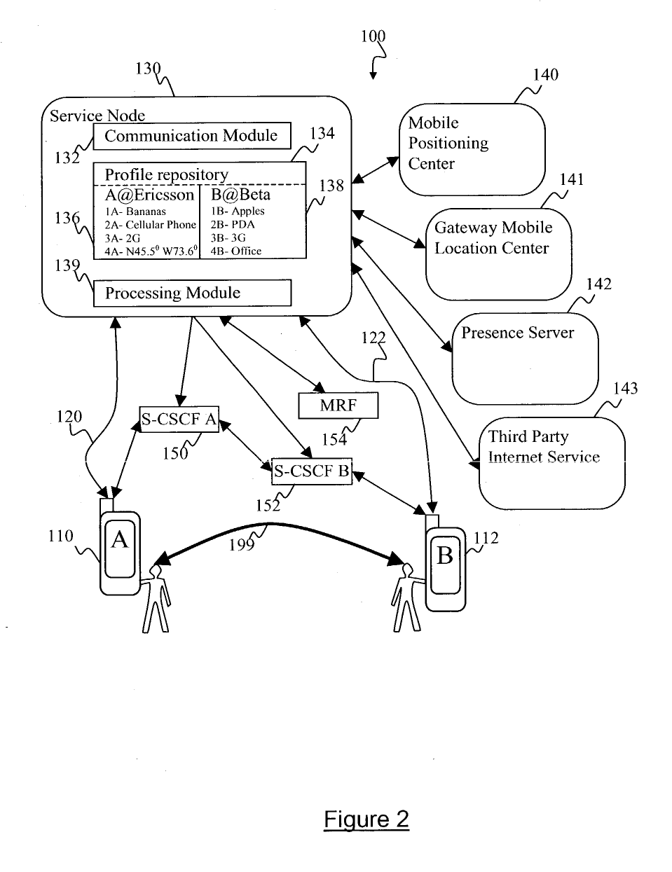

Whenever there are at least two registered users to the face-to-face service, step 230 of processing the user profiles of the registered users can be performed. The step 230 is performed each time registration of a user is completed (such as in the steps 222A and 222B) or in a periodic manner (e.g. each 30 seconds). The step 230 of processing the user profiles of the registered users uses information 235 exchanged with the profile repository 134. All details of the step 230 will be described furthermore later on in the discussion taking into account FIG. 2. Following the registration confirmation messages 224A and 224B, the users A 110 and B 112 may send a request to the service node 130 in order to get in touch with a specific registered user. In such a case, the request would be taken into account by the service node 130 when performing the step 230.

As a result of the step 230, at least one communication message is sent to a registered user. The communication message contains information about one other registered user who has a user profile that has been identified by the step 230 as compatible with the registered user's user profile. The communication message usually contains information found in the user profile of the other registered user. It may also contain links to other aspects of the face-to-face service. In the example of FIG. 1, two communication messages 240A and 240B are sent from the service node 130 respectively to the user A 110 and the user B 112. Following reception of the communication messages 240A and 240B, the user A 110 and the user B 112 may get in electronic communication with each other 250. The electronic communication 250 may take multiple forms including regular voice calls, chatting and video conferencing. Ultimately, even though no electronic communication 250 occurs, a physical face-to-face communication 199 may be enabled between the user A 110 and the user B 112 by providing information in the form of the communication 240A an 240B to at least one of the users A 110 and B 112. It should be noted that more that one communication messages 240A and 240B can be sent respectively to the users A 110 and B 112. Moreover, the communication messages 240A and 240B can be sent before or after the establishment of the physical face-to-face communication 199. However, for clarity purposes, only one communication 240A and one communication 240B are presented prior to the establishment of the physical face-to-face communication 199 for each user A 110 and B 112.

To better illustrate the functioning of the present invention, examples of what can be provided in the communication 240A are given hereinafter. In order for the registered users to find each other, a map may be provided showing their respective location. It can be provided as an image or an interactive web page with links to instructions on how to reach the other user as daft as possible. The web page can be built using Hypertext Markup Language (HTML), eXtensible Markup Language (XML), any type of scripting language (e.g. JavaScript, VBScript). Also, the communication 240A can be provided to the user in various forms including the well-known SMS message or MMS message. A SIP-based message could also be used for the communication message 240A and 240B. As it can be appreciated, the communication 240A and 240B can provide information found in the user profiles or not found in the user profiles.

Again, to better illustrate the functioning of the present invention, an example of the electronic communication 250 in the form of a voice call is described hereinafter using a Call State Control Function (CSCF) architecture. A simplified view of the CSCF architecture is shown on FIG. 1 (nodes 150 and 152). The CSCF architecture includes a Serving-CSCF (S-CSCF) node 150 serving the user A 110 and a S-CSCF node 152 serving the user B 112. Both users A 110 and B 112 can be served by the same S-CSCF 150 or 152 without affecting the teachings of the present invention. Other CSCF nodes such as a Proxy-CSCF and an Interrogating-CSCF are not shown on FIG. 1 and are omitted for clarity purposes in the exemplary establishment of the voice call. For establishing the voice call between the user A 110 and the user B 112, the service node 130 contact both the S-CSCF 150 and 152 with SIP messages instructing them to establish a call therebetween. F more than two users are to take part to the voice call, a Multimedia Resource Function (MRF) node 154 may be use to coordinate the conferencing aspect of the voice call.

For the exemplary voice call to be established properly, the service node 130 typically acts as a SIP Back-to-back User Agent (B2BUA). In this case, the service node 130 issues SIP invitations to both users A 110 and B 112. It could also use another conferencing oriented interface towards the MRF node 154 such as Parlay/OSA.

Each registered user may also deregister from the face-to-face service. It can be achieved voluntarily at any time by sending a deregistration message (not shown) to the service node 130. For example, the deregistration message may be sent from an interactive web page provided to the registered user upon registration. Deregistration from the face-to-face service may also occur automatically following an event in the telecommunications network 100. For example, deregistration may automatically occur if a registered user exits a predefined geographical area in which the face-to-face service is provided. Another example of automatic deregistration occurs when a registered user decides to turn off its user equipment, thus triggering deregistration at the service node 130. Yet another example of automatic deregistration may happen without the use of the deregistration message following expiring of a timer in the service node 130. An exemplary use of the timer is to track that a registered user makes use of the face-to-face service in a predetermined period (e.g. at least once every hour). A step of deregistration (not shown) then takes place at the service node 130. Following the step of deregistration, a deregistration confirmation message (not shown) may be sent to the newly deregistered user to confirm termination of the deregistration process. Once again, the deregistration can be the result of a SIP NOTIFY message sent from a presence server.

Reference is now made to FIG. 2, which shows an exemplary schematic representation of a nodal architecture of a face-to-face service implementation in a telecommunications network 100. The user A 110 and the user B 112 are presented using the face-to-face service with the use of a user equipment (UE). It should be readily understood that any kind of UE having networking capabilities could be used to access the face-to-face service such as, for example, a mobile phone, a Personal Digital Assistant (PDA), a portable computer or a fixed computer.

FIG. 2 also shows the service node 130 for providing the face-to-face service. The service node 130 contains a communication module 132 capable of communicating with the users A 110 and B 112 and with other nodes of the telecommunications network 100. The communication module is further capable of communicating with the others nodes using proprietary interfaces and various telecommunications standards such as, for example, Signaling System 7 (SS7), SOAP (Christophe: definition please), Internet Protocol (IP) and CAMEL (Christophe: definition please).

The service node 130 communicates with the users A 110 and B 112 respectively on links 120 and 122. Each link 120 and 122 is shown as one connection between the service node 130 and each user A 110 and B 112. However, in most implementations, the links 120 and 122 comprise various interconnections between telecommunications nodes (not shown) such as Base Stations (BS), Mobile Switching Centers (MSC), Home Location Registers (HLR), etc. For example, the link 120 may be composed of a wireless connection from the user A 110 to a BS (not shown). The telecommunications standard used on the wireless connection is not relevant to the present invention and, therefore, any standard may be used therebetween. In the same example, the BS may then connect with an MSC (not shown) on a Signaling System 7 (SS7) connection (not shown). The MSC may then further connect to the service node 130 on an IP connection (not shown). It should also be noted that, in IPMM, the S-CSCF 152 or 150 itself is a privileged way to communicate with the users A 110 and B 112. Other nodes such as a GGSN (Gateway General Packet Radio Service (GPRS) Support. Node) and a SGSN (Serving GPRS Support Node) may also be used thereto.

The service node 130 further comprises the profile repository 134 capable of maintaining user profiles for each user of the face-to-face service. FIG. 2 shows the profile repository 134 inside the service node 130, but it should be noted that other implementations of the face-to-face service could make use of an outside profile repository (not shown) for replacing or complementing the profile repository 134.

In some implementations, the service node 130 is hosted by a SIP Application Server (SIP AS). In such a case, it can be collocated with other SIP-based services and servers such as or a presence server.

In FIG. 2, the profile repository 134 is shown with the two profiles A@Ericsson 136 and B@Beta 138 respectively associated with the users A 110 and B 112. The profile repository 134 is, of course, capable of maintaining a plurality of user profiles simultaneously to accommodate for the face-to-face service requirements. Moreover, as mentioned earlier, a single user may have a plurality of user profiles in the profile repository 134. In most implementations, each user profile is linked to a user of the face-to-face service with a Session Initiation Protocol (SIP) Unique Resource Identifier (URI). For instance, in FIG. 1, the user A 100 has a SIP URI equal to SIP:A@Ericsson.com and the user B 112 has a SIP URI equal to SIP:B@Beta.com. The SIP URI is obtain by the user from a service provider from which each user is able to connect to the service node 130. In other implementations, each user profile can be identified with an email address (e.g. mailto:A@ericsson.com), a text string (e.g. “A at Ericsson”) or any other type of unique identifier (e.g. 1234567890).

Each user profile 136 and 138 contains at least one information field related to the associated user, but usually contains a plurality of such information fields. Various categories of information field may be used to classify the information contained in a typical user profile. In each category of information field, there can be various types of information. Each type of information is linked to one of the category of information fields and to a source of information. To simplify the presentation of the various arrangements of categories, types of information and sources of information, a table containing exemplary categories of information field with their related type of information and their related source of information is provided thereafter.

TABLE 1
Exemplary information fields.

| Category | Type of information | Source of information |
|---|---|---|
| interest | Text information; | Drop down list provided by the service; |
| | Reference number to a known list; | Custom drop down list built by the user; |
| | List of related interests. | Text entered by the user. |
| location | Name of a place known to the user | By the user |
| | (e.g. office, home, pool) | From a drop down list provided by the service; |
| | Longitude and latitude (GPS | From a custom drop down list built by the user; |
| | coordinates); | In clear text; |
| | Street name or names (e.g. highway | By the service: |
| | exit, major road, streets | From its own computation; |
| | intersection); | From other nodes (140 to 143) of the |
| | Civic address; | telecommunications network 100. |
| | Known landmark of a city (e.g. park, | |
| | building, monument, skyscraper; ball | |
| | park; football field); | |
| | Metro station; | |
| | Bus stop; | |
| | Nearest base station or network | |
| | equipment of the | |
| | telecommunications network 100; | |
| | List of related locations. | |
| network | Activated services (e.g. call display | By the user: |
| capability | (callerID), click to dial, | From first registration information; |
| | conferencing); | From requests during service use; |
| | UE identification or listing (if more | By the telecommunications |
| | than one UE associated to on user | network 100 (e.g. HLR, S-CSCF); |
| | profile); | By the presence server. |
| | UE capabilities (e.g. Java ™ 2.0, | |
| | XML, WAP 1.1, SIP) | |
| | Technology generation (e.g. 2 G, | |
| | 2.5 G, 3 G, 4 G). | |
| personal | Text information; | By the user: |
| | UE number or listing (if more than | From first registration information; |
| | one UE associated to on user | From requests during service use; |
| | profile); | By the service: |
| | Email address; | From the telecommunications |
| | Other personal information (e.g. | network 100 (e.g. HLR, S-CSCF); |
| | home phone number, home address, | By the presence server. |
| | sex, age); | |
| | A picture or physical description to | |
| | be recognized more easily; | |
| | A personal web page (e.g. formatted | |
| | in HTTP, XML, etc.). | |
| restriction | List of people who can communicate | By the user: |
| | with me; | From first registration information; |
| | List of people who cannot can | From requests during service use. |
| | communicate with me. | |
| preferences | Confidentiality information (e.g. | By the user; |
| | authorization to disclose information | By the service: |
| | to other registered user); | From the telecommunications |
| | Distance between matched users | network 100 (e.g. HLR, S-CSCF). |
| | (e.g. maximum walking distance); | |
| | Maximum size of messages; | |
| | Minimum closeness of interest | |
| | match (e.g. at least two common | |
| | interests, not more than 4 common | |
| | interests, at least one interest close to | |
| | mine, exact match, same type of | |
| | interest); | |
| | Minimum closeness of location | |
| | match (e.g. exact match, same area, | |
| | less than 2 km); | |
| | Network preferences (e.g. | |
| | conferencing activated, callerID | |
| | deactivated); | |
| | Which UE should be used. | |

A typical user profile enables a user, via the information fields, to explicitly accept or decide to have location information transmitted to other registered users. For example, a communication message 240A can be sent to the user A 110 requesting the permission to send the location information to the user B 112. It should also be noted that the typical user profile is not stored in a single memory space of the service node 130. Indeed, some information fields may be stored in permanent storage areas such as a hard disk drive while some other information fields may be stored in volatile storage areas such as Random Access Memory (RAM).

Each information field of a given user profile may also have a category identifier. The category identifier can be a letter or number referencing a known list of categories or a text string naming the category. In FIG. 1, each user profile 136 and 138 lists the information in the same order thus avoiding the need for such category identifier. In the example of FIG. 1, the user profiles A@Ericsson 136 and B@Beta 138 contain four (4) information fields related to their respective users A 110 and B 112. In each user profile, the first information field relates to an interest, the second to a preference, the third to a network capability and the fourth to a location. Reference to the information fields of the user profiles A@Ericsson 136 and B@Beta 138 will be made later on.

The service node 130 also comprises a processing module 139 for providing the face-to-face service. The processing module 139 contains face-to-face service logic enabling users of the face-to-face service to meet each other. The face-to-face service logic will be described in the following paragraphs with particular reference to the profile repository 134, the users A 110 and B 112 with their associated user profiles 136 and 138 and the step 230 of processing the user profiles of the registered users. Again, it should be understood that this only represents an exemplary use of the face-to-face service logic, which is capable of answering all requirements from the face-to-face service.

Reference is now made concurrently to FIG. 1 and FIG. 2 to better understand the functioning of the present invention. The user profiles used during the step 230 are the ones pertaining to registered users (as explained earlier). The user profiles are analyzed by the processing module 239 using the face-to-face service logic. In the following example, both the user A 110 having the user profile A@Ericsson 136 and the user B 112 having the user profile B@Beta 138 are registered in the service node 130. The step 230 of processing the user profiles of the registered users is performed for enabling the physical face-to-face communication 199 between at least two users of the face to face service. This is achieved by analyzing the user profiles of registered users to identify compatibility between at least two user profiles. In the present context, the compatibility of at least two user profiles is defined as a close match between information entered in the user profiles. As mentioned earlier (in Table 1), the closeness of the match may be specified by the user or by the face-to-face service. The physical face-to-face communication 199 between at least two users of the face to face service is enabled by providing information found in the compatible user profiles to at least one of the users having the compatible user profiles.

For example, the interest information fields of the user profile A@Ericsson 136 and of the user profile B@Beta 138 are respectively “Bananas” and “Apples”. If the closeness of the match is specified as, for example, “exact match”, the two user profiles 136 and 138 are not said to be compatible. On the other hand, if the closeness of the match is specified as “same type of interest”, the two user profiles 136 and 138 may be compatible. Indeed, both interests relate to “Fruits”. In such a case, the list of related interests is used to determine the closeness of the match and both “Bananas” and “Apples” must have “Fruits” in their list of related interest. It is possible to imagine different levels of match depending on how the list of related interests is built by the user or the face-to-face service. In the same example, the compatibility of the two user profiles 136 and 138 would not be the same for “round fruits” as it is for “fruits”.

The same sort of analysis can be performed for other information fields including location. In fact, the location information fields should be analyzed during the step 230 of processing the user profiles of the registered users. Again, the user profiles are analyzed by the processing module 239 using the face-to-face service logic. The location information contained in the information fields of the user profiles can be obtained in various ways as specified in Table 1. In the example of FIG. 1, the telecommunications network's 100 nodes 140 to 143 are able to provide the location information. The presence server 142 may provide an initial location, together with other presence information. A Mobile Positioning Center (MPC) 140 and a Gateway Mobile Location Center (GMLC) 141 can be queried by the presence server 142 therefore. The location information can also some directly from a Global Positioning System (GPS)-enabled UE.

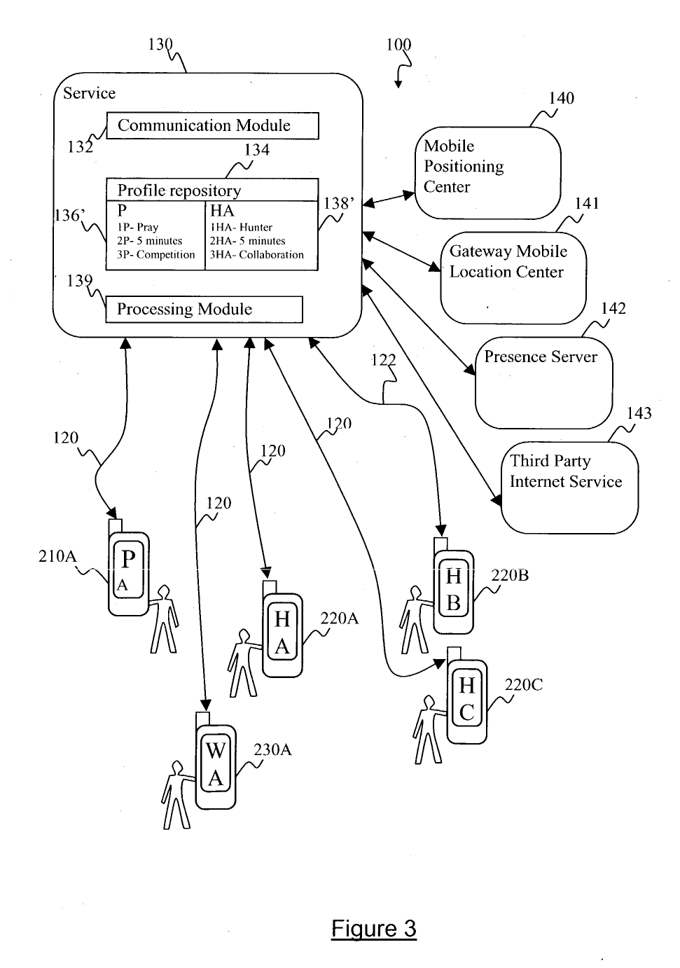

Reference is now made to FIG. 3, which shows an exemplary schematic representation of a node architecture of the face-to-face service implementation in a telecommunications network 100 in the context of a manhunt-type game. The manhunt-type game shown on FIG. 3 proposes to use the above-described face-to-face service to play hide and seek on a town scale. FIG. 3 shows a user PA 210A acting as a pray of the game, three users HA 220A, HB 220B and HC 220C acting as hunters of the pray 210A and a user WA 230A acting as a passive watcher of the game. The manhunt-type game makes use of the face-to-face service by adapting the content of a typical user profile with specific information fields related to the game itself. A table follows with more specific details about the specific information fields.

TABLE 2
Exemplary information fields related to the manhunt-type game.

| Category | Type of information | Source of information |
|---|---|---|
| role | Role the user wishes to play(e.g. | Drop down list provided by the service; |
| | watcher, hunter, pray); | Custom drop down list built by the user; |
| | Time availability of the user (e.g. | Text entered by the user. |
| | available if an instance of the game | |
| | starts within 15 minutes (or before | |
| | 11:38 AM)); | |
| | Active role of an instance of the | |
| | game (e.g. hunter in game #123). | |
| game | Refresh rate of location information | Drop down list provided by the service; |
| preferences | (e.g. each minute, each 5 minutes, | Custom drop down list built by the user; |
| | variable depending on the time left | Text entered by the user. |
| | or elapsed in an instance of the | |
| | game, variable depending on the role | |
| | (e.g. watcher: always, pray: each | |
| | minute, hunter: each 2 minutes)); | |
| | Length of the instance of the game | |
| | (e.g. 30 minutes, indefinite); | |
| | Number of pray(s), hunter(s) and | |
| | watcher(s) (minimum and | |
| | maximum); | |
| | Number of pray(s) to be discovered | |
| | before ending an instance of the | |
| | game (e.g. all prays discovered, 1 | |
| | pray discovered); | |
| | Type of collaboration within a given | |
| | role (e.g. collaboration between the | |
| | prays and competition between the | |
| | hunters, competition everywhere, | |
| | collaboration everywhere); | |
| | Preferred communication means | |
| | between players (e.g. instant | |
| | messaging, voice, video, MMS, | |
| | SMS); | |
| | Visibility settings (e.g. location of | |
| | watchers is given to every users of | |
| | the instance of the game or to prays | |
| | only, location of hunter can be given | |
| | to each other). | |

The game uses the processing module 239 and the face-to-face service logic to elect a set of compatible registered users into a specific instance of the manhunt-type game. The service node 130 takes into account the games preferences to process the specific information fields related to the game. The service node 130 further needs to keep track of each game by, for example, assigning a unique number to each ongoing instance of the game (e.g. #123).

The players of a given instance of the manhunt-type game may be selected in a set of friends, or among people who do not know each other. This preference can be specified in the restriction category or in the game preferences category.

An instance of the manhunt-type game starts when enough registered users are present for all criteria in the games preferences to be met. In the example of FIG. 3, the criteria may be that at least 3 hunters and 1 pray are available. In such a case, the step 230 of processing the user profiles of the registered users presented on FIG. 1 include taking into account the games preferences entered in the user profiles. The communication messages 240A and 240B presented on FIG. 1 further enable the instance of the manhunt-type game to start when the registered users reply thereto.

In the example shown on FIG. 3, the instance of the game ends when a first one of the hunters HA 220A, HB 220B and HC 220C establishes a physical face-to-face communication with the pray PA 210A or upon expiration of a timer specifying the length of the instance of the game (as mentioned in the game preferences). If more than one pray PA 210A is present in one particular instance of the game, the games preferences are used to determine the end of the instance of the game.

The instance can be maintained by the processing module 139 of the service node 130. In such a case, the game preferences computation as well as the start and the end of the instance of the man-hunt type game are performed by the processing module 139.

During the course of a given instance of the manhunt-type game or upon its end, statistics about the instance may be sent to the users. The statistics can take the form of communication messages such as the communication messages 240A and 240B described with reference to FIG. 1.

A provider of the face-to-face service may charge communications induced by the manhunt-type game or by the generic use with specific rates. The rates may be specified in the same kind of statistical communication message 240A and 240B. As such, the face-to-face service can be seen as a way for the service provider to boost communications within the telecommunications network 100.

The innovative teachings of the present invention have been described with particular reference to numerous exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views, and the various elements depicted are not necessarily drawn to scale.

What is claimed is:

1. A method for enabling a face-to-face meeting between users of a face-to-face service of a telecommunications network wherein the face-to-face service has a plurality of users subscribed thereto, the method comprising steps of:
registering a plurality of users of the face-to-face service, each of the plurality of users having an associated user profile;
marking the associated user profiles pertaining to the plurality of registered users;
processing the marked user profiles to identify at least two compatible user profiles;
enabling a physical face-to-face communication between at least two users having the at least two compatible user profiles by providing information found in the compatible user profiles to at least one of the at least two users having the compatible user profiles.

2. The method of claim 1 wherein the step of registering a plurality of users further comprises a step of providing an interactive web page.

3. The method of claim 1 wherein each associated user profile contain at least one information field about the user to which the associated user profile pertain.

4. The method of claim 3 wherein the step of processing the marked user profiles further comprises finding a match between the at least one information field of the marked user profiles.

5. The method of claim 1 wherein the step of enabling a physical face-to-face communication further comprises providing an interactive web page to the at least one user.

6. The method of claim 1 further comprising starting an instance of a manhunt-type game.

7. The method of claim 6 wherein the step of establishing a physical face-to-face communication between the at least two users having the compatible user profiles further comprises ending the instance of the manhunt-type game.

8. The method of claim 1 further comprising a step of communicating with at least one user to which one of the at least two compatible user profiles pertain.

9. The method of claim 9 wherein the step of communicating further comprises providing information not found in the user profiles.

10. A service node for providing a face-to-face service in a telecommunications network, the service node comprising:
a profile repository capable of:
maintaining user profiles having information about users of the face-to-face service; and
marking a plurality of user profiles pertaining to registered users of the face-to-face service;
a processing module capable of:
processing the marked user profiles to identify at least two compatible user profiles; and
a communication module capable of:
communicating with other nodes of the telecommunications network; and
communicating with the users of the face-to-face service by providing information found in compatible user profiles to at least one registered user of the face-to-face service so as to enable a physical face-to-face communication between compatible users.

11. The service node of claim 10 wherein the information about users of the face-to-face service is categorized with information fields.

12. The service node of claim 10 wherein processing the marked user profiles further comprises finding a match between the at least one information field of the marked user profiles.

13. The service node of claim 10 wherein the profile repository is further capable of maintaining user profiles having information about registered users of the face-to-face service playing a role in an instance of a manhunt-type game.

14. The service node of claim 10 wherein the processing module is further capable of maintaining an instance of a manhunt-type game.

15. The service node of claim 14 wherein maintaining an instance of manhunt-type game further comprises starting and ending the instance of the manhunt-type game.
